(19) United States
(12) Patent Application Publication
(10) Pub. No.: US 2012/0203954 A1
(43) Pub. Date: Aug. 9, 2012

(54) DATA STORAGE DEVICE

(75) Inventors: Rixin Sun, Guangdong (CN); Zhenhua Li, Guangdong (CN)

(73) Assignee: BIWIN TECHNOLOGY LIMITED, Hong Kong (CN)

(21) Appl. No.: 13/256,158

(22) PCT Filed: Jul. 30, 2010
(86) PCT No.: PCT/CN2010/075602

§ 371 Date: Sep. 12, 2011

(30) Foreign Application Priority Data
Jun. 25, 2010 (CN) PCTCN2010074540

(51) Int. Cl. G06F 12/00

(52) U.S. Cl. 711/103; 711/E12.008

(57) ABSTRACT

A data storage device comprises a multichannel flash memory assembly which is constructed by stacking of flash memory members. The data storage device is compact due to the use of stacked flash memory members which provides high speed performance due to its multiple data channel arrangement. A specific example is the use of a flash memory assembly comprising 4 stacked flash memory dies with 4 parallel data channels. This invention is advantageous because it provides a data storage device having a high data storage capability at high data transfer rates while maintaining a compact construction due to the high-rise stacked architecture.

### FIELD OF THE INVENTION

The present invention relates to data storage devices such as USB flash drives and USB memory sticks, and more particularly to data storage devices comprising a stack of flash memory members such as flash memory chips or dies. The present invention also relates to electronic data storage apparatus comprising a stacked assembly of flash memory members.

### BACKGROUND OF THE INVENTION

Memory devices as electronic data storage are essential to the operation of many electronic apparatus, especially electronic apparatus controlled or controllable by a computer or a microprocessor. Such memory devices include USB memory sticks, solid state disks (SSD), mobile Internet device (MID), etc. Among the various types of memory devices, flash memory is gaining increasing popularity due to its high performance-to-cost ratio, high data storage density, being solid state and being non-volatile. Whilst flash memory already represents a substantial improvement and advancement over predecessor memory devices, the ever increasing demand for ever higher data storage capacity means there is always a need to pack more flash memory into a single compact housing.

FIGS. 1 and 1A schematically show a prior art stacked flash memory assembly which utilizes a high-rise structure to increase data storage capacity. The memory assembly comprises a plurality of flash memory dies 102, 104, 106, 108 the data access terminals are bonded in a cascade manner. However, the performance of such a stacked flash memory assembly is not entirely satisfactory due to a data access bottle-neck at the bottom flash memory member in the stack. Furthermore, a defective data access terminal on one flash memory member may also cause malfunction of the corresponding data access terminals on other flash memory members in the stack.

### SUMMARY OF THE INVENTION

According to the present invention, there is provided a data storage device comprising a multichannel flash memory assembly, the flash memory assembly comprising a plurality of stacked flash memory members. A data storage device comprising a multichannel stacked flash memory assembly is particularly advantageous because it could provide high data storage capability at high data transfer rates while maintaining a compact construction due to the high-rise stacked architecture.

In an embodiment, the data storage device is adapted for USB 3.0 or SuperSpeed Universal Serial Bus applications.

For example, the flash memory assembly may be adapted for multichannel data transfer at a maximum speed of 4.8 gigabit-per-second (Gbps). This provides compatibility with the USB 3.0 standard for fast data transfer applications.

The flash memory is NAND type, and the device may comprise a NAND controller which is arranged to cooperate with the flash memory assembly to effect date transfer between the controller and the flash memory assembly in a plurality of channels in parallel.

The device may comprise a main controller and a USB 3.0 PHY interface, the main controller being arranged to negotiate data transfer between the NAND controller and the USB 3.0 PHY interface.

In one embodiment, the device further includes a USB 2.0 PHY interface, and the main controller being also arranged to negotiate data transfer between the NAND controller and the USB 2.0 PHY interface. This facilitates compatibility of the device with both USB 2.0 and USB 3.0 compatible devices.

### BRIEF DESCRIPTION OF THE FIGURES

The invention will be explained by way of example and with reference to the accompany drawings, in which:

FIGS. 1 and 1A are respective side and perspective views of a prior art stacked flash memory assembly,

FIGS. 2 and 2A show respectively side and perspective schematic views of a memory device illustrating a first embodiment of the present invention,

FIGS. 3 and 3A show respectively side and perspective schematic views of a memory device illustrating a second embodiment of the present invention,

FIG. 4 is a schematic plan view showing a relationship of the wire bonding and the wire bonding terminals of the memory device of FIG. 2,

FIGS. 5 and 5A are respectively schematic block diagrams depicting a memory device of FIGS. 2, 3 and 8 and an exemplary application as a USB device,

FIGS. 6A and 6B are respectively schematic diagrams illustrating a distribution of contact terminals on a PCB of the device of FIG. 2, and an enlarged view of one of the contact regions,

FIG. 7 is a perspective schematic view of the device of FIG. 2 showing the I/O (input/output terminals) in more detail,

FIGS. 8 and 8A are perspective schematic views depicting a flash memory assembly of a third embodiment of the present invention respective in assembled and part assembled form,

FIG. 9 is a schematic block diagram of a flash memory drive incorporating a flash memory assembly of the present invention,

FIG. 10 is a longitudinal cross-sectional side view of a flash memory drive according to the block diagram of FIG. 9 and illustrating an embodiment of the data storage device of the present invention,

FIGS. 10A and 10 B are perspective views from above and below of the storage device of FIG. 10 with covers removed,

FIG. 10C is a schematic diagram depicting the running of connection leads between the flash memory assembly and the NAND controller.

FIGS. 11 & 11A-11C are various views corresponding respectively to FIGS. 10, & 10A-11C illustrating a second construction embodiment of the flash drive of FIG. 9,

FIG. 11D1-11D3 depicts, respectively, running of connection leads on the IC 582 side and the flash memory assembly side, as well as a side view of the dispositions of the IC 582 and the flash memory stack of FIG. 11,

FIGS. 12 & 12A-12C depicts a third construction embodiment of the flash drive of FIG. 9 and the various views correspond respectively to that of FIGS. 10 & 10A-10C,

FIGS. 13 & 13A-13C depicts a fourth construction embodiment of the flash drive of FIG. 9 and the various views correspond respectively to that of FIGS. 11 & 11A-11C, and

FIG. 13D1-13D3 depicts, respectively, running of connection leads on the IC 582 side and the flash memory assembly side, as well as a side view of the dispositions of the IC 582 and the flash memory stack of FIG. 13.

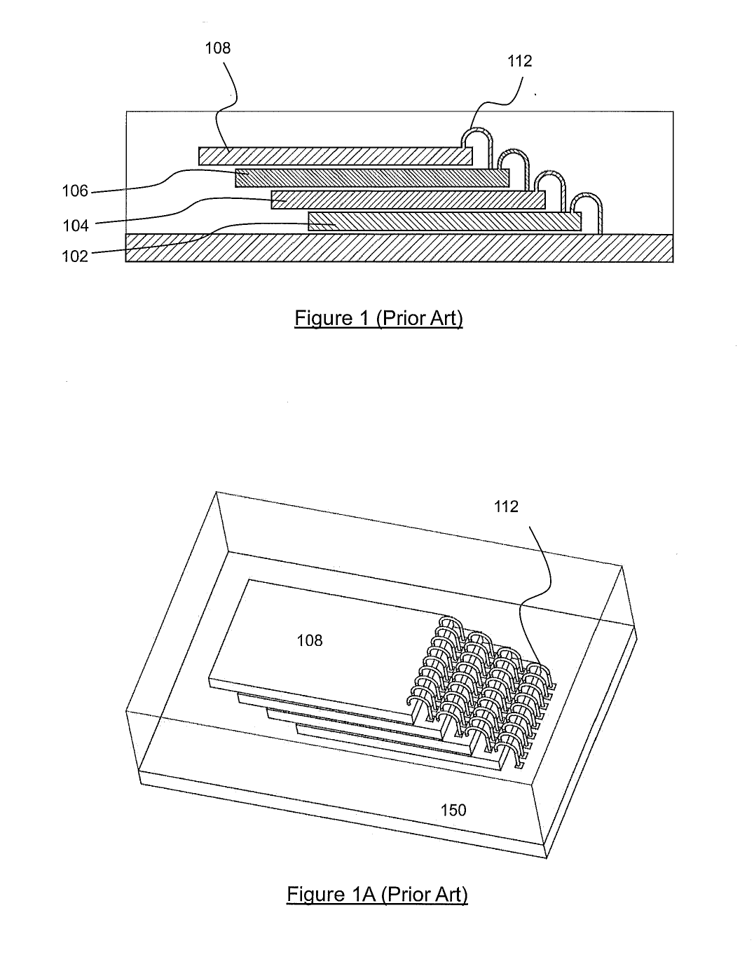

### DETAILED DESCRIPTION OF EXEMPLARY EMBODIMENTS

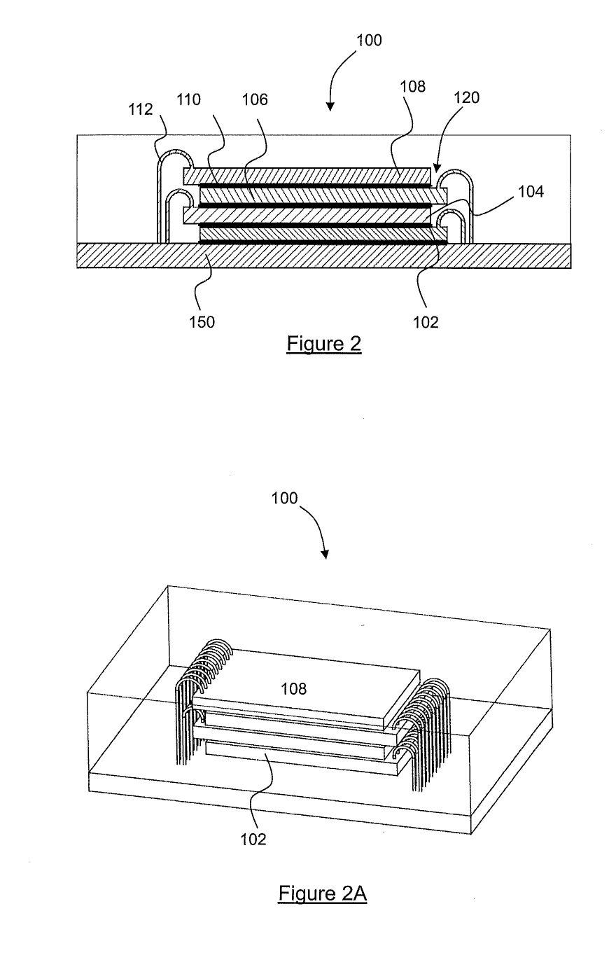

A flash memory assembly 100 of FIGS. 2, and 2A as an example of a memory device comprises a stack of 4 flash memory dies 102, 104, 106, & 108 each having a plurality of contact terminals 120 or contact ports for making external electrical connections. Each memory die is pre-fabricated with solid state and non-volatile memory cells and has a definitive storage capacity. Currently, flash memory dies are available in 1, 2, 4, or 8 gigabyte capacity. Of course, the storage capacity of an individual memory die or chip depends on the die size and the density is expected to increase with further improvements in die design and fabrication technology. The memory die used in the present example is a rectangular die having an exemplary dimension of 10.8 mm×13 mm. For example, by stacking four 1-gigabyte dies together, a single 4 gigabyte flash memory chip is formed. Likewise, a single 16 gigabyte flash memory is formed by stacking four 4-gigabyte flash memory dies.

The contact terminals 120 of each memory die 102-108 include data access terminals 130 such as data input and data output terminals, and other terminals 140 such as control terminals and power supply terminals. The data access terminals collectively define a multi-bit data communication channel for access to the die. The number of I/O terminals on each die is typically determined by the size of a byte. For example, if the byte size is 8-bit, each data communication channel would include 8 I/O terminals to facilitate 8 bit communication. Likewise, I/O terminals would collectively define a communication channel if the byte size is 16-bit. Because the unit of useable data is dependent on the byte size, the speed of a memory device is largely determined by the speed of the data communication channel since all data transfer to and from the die has to be through the communication channel.

The flash memory dies, as an example of flash memory members, are stacked in a high-rise manner using the “die-stacking” technique and adjacent flash memory dies, that is, dies above and below the die, are joined together by applying a thin film of insulating glue 110. The assembly comprising the stack of glued dies is then glued on a PCB 150, as an example of a substrate, by applying a thin film of insulating glue. The contact terminals on a memory die are connected to the contact terminals on the PCB by bonding wires 112.

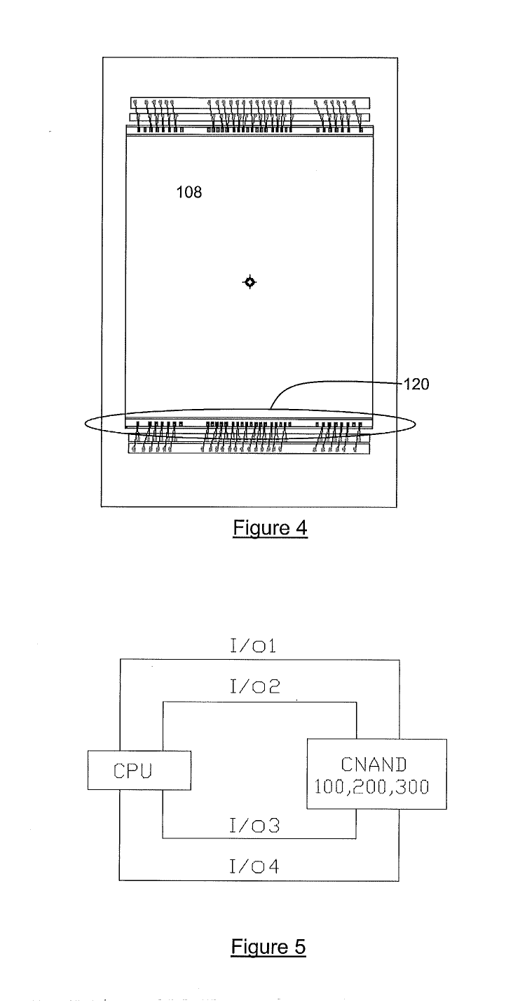

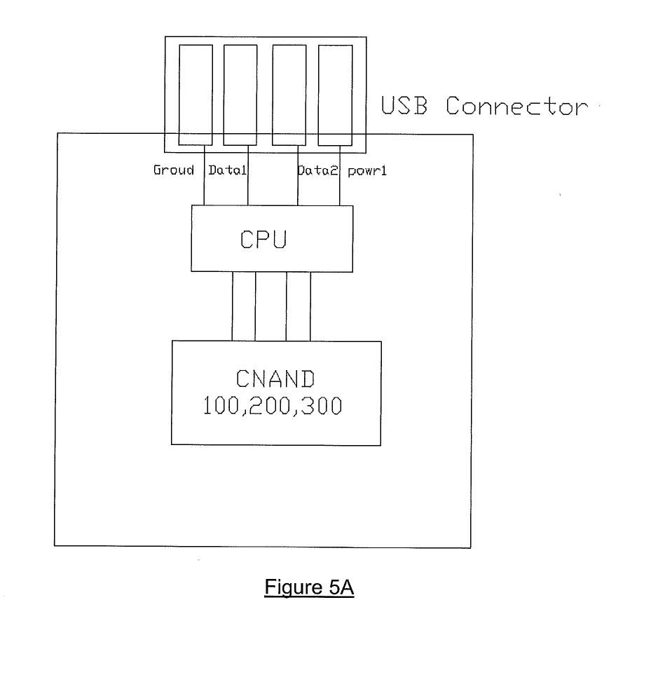

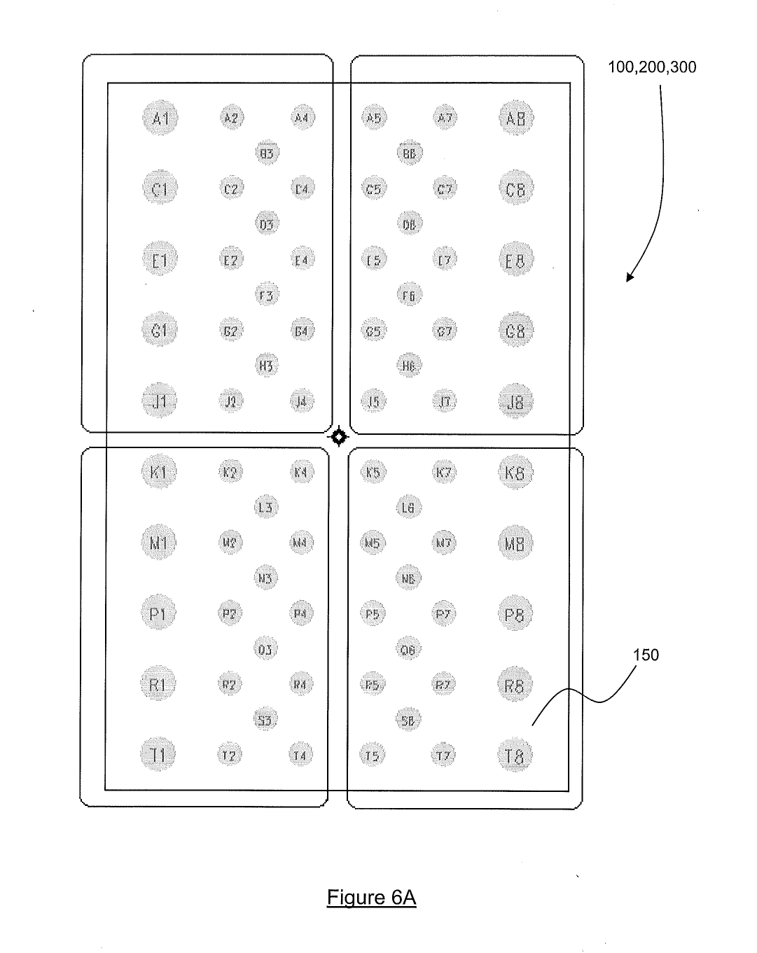

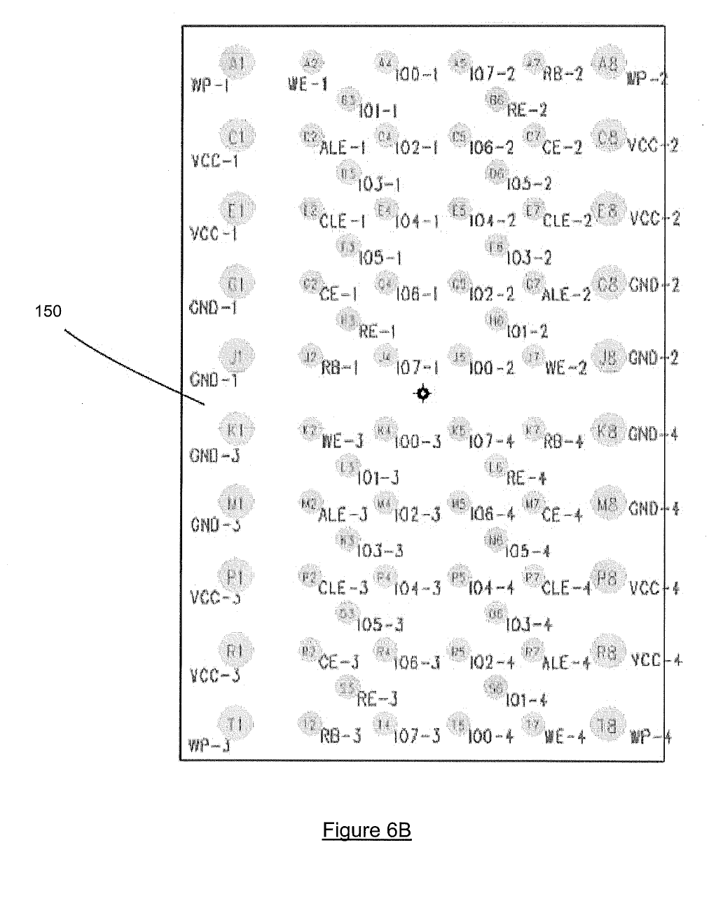

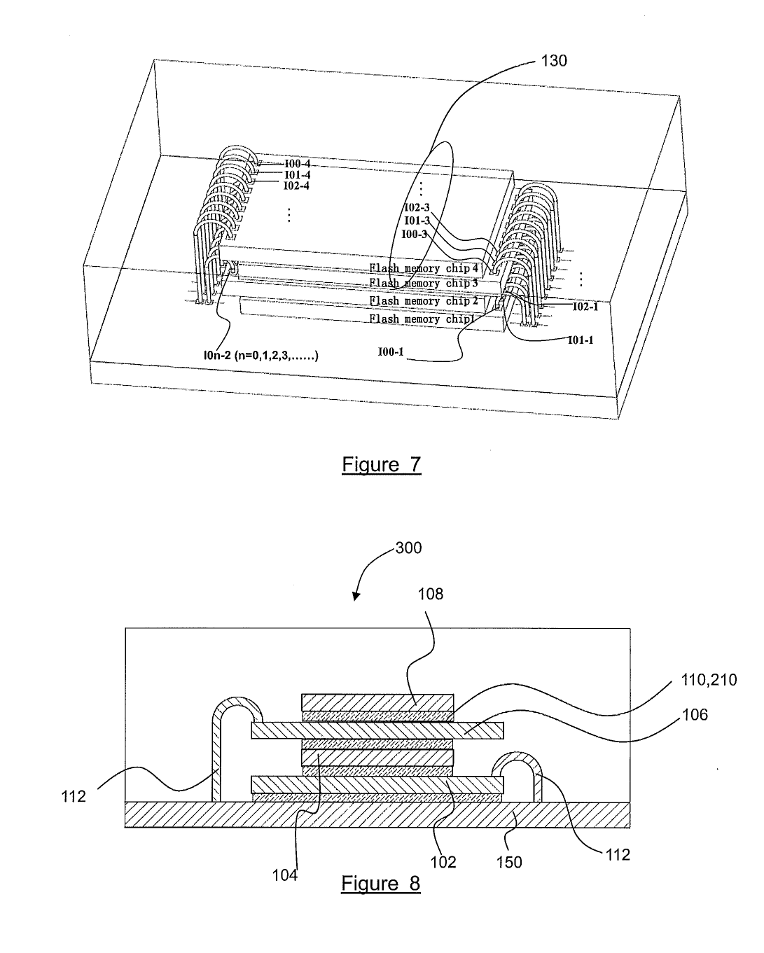

As shown more clearly in FIGS. 2, 2A and 4, all the contact terminals of a die are located on a contact portion which is located at one lateral end portion of the die. The stacking of dies is arranged such that the contact portion is exposed after stacking to permit external electrical connections to be made. The contact portion of a die protrudes from the stack and overhangs adjacent dies in the stack to provide a path and space for the bonding wires to negotiate from the die to the substrate. As shown more particularly in FIGS. 2 and 4, each one of the I/O terminals on a die is individually bonded on the substrate with bonding wires 112, such that each I/O terminal (and therefore data) on a die could be directly accessible without interfering with or being interfered by I/O terminals of other dies. This individual I/O connection arrangement facilitates parallel data access while using the die-stacking structure, as illustrated schematically in FIG. 5. As shown in FIGS. 6A and 6B, the PCB is arranged so that all the contact terminals of a die are located in a specific region on the PCB. This localized connection organization on the PCB facilitates easy identification and tracing of the individual terminals of an individual die in the stack.

As shown more particularly in FIGS. 2 and 2A, the dies are organized such that the contact portion of one die is on one lateral end, while that of an adjacent die is on the direct opposite lateral end. This zigzag stacking facilitates a more balanced and symmetrical stacking to facilitate a more stable structure and enables more dies to be stackable in a stack to further increase storage capacity. In addition, this stacking arrangement also provides a more space efficient arrangement for the bonding wire to negotiate when extending from the die to the PCB.

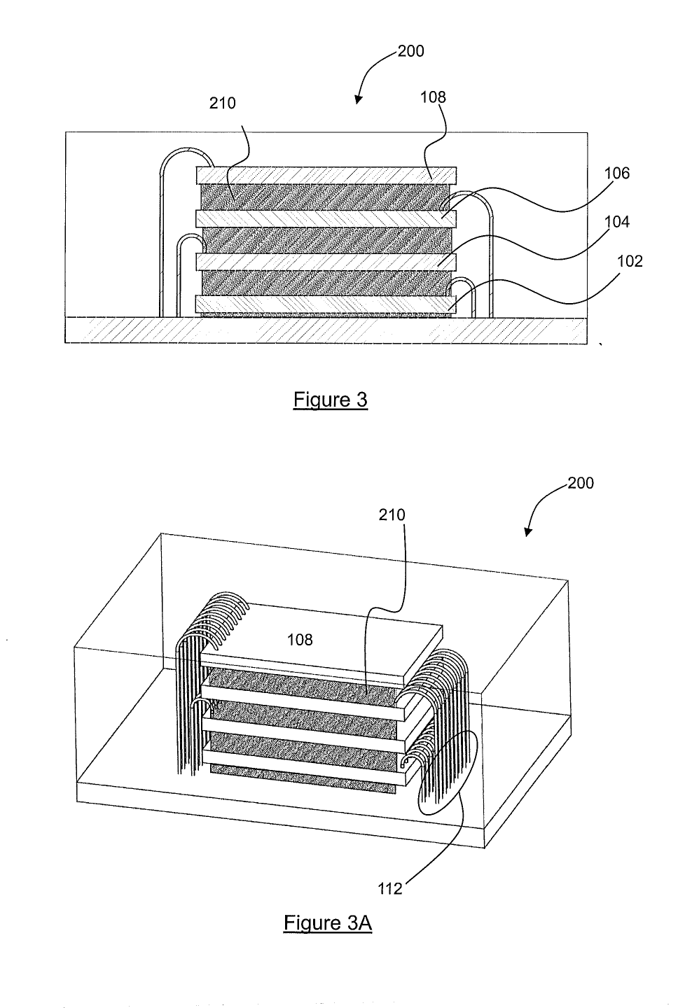

The stack assembly 200 of FIGS. 3 and 3A has a structure substantially identical to that of FIGS. 2 and 2A and same numerals are used to refer to same, common or equivalent parts. Instead of applying a thin film of insulating glue between the memory dies, the stack assembly 200 comprises includes a thick insulating glue layer 212 which also functions as a spacer between adjacent dies. The insulating spacer provides sufficient spacing so that bonding wires could extend upwardly initially without being obstructed by the die above and without the need of having a retreated die like that of the embodiment of FIG. 2. In particular, it will be noted that the lateral ends or the wire bonded ends of the dies of this assembly are substantially flush.

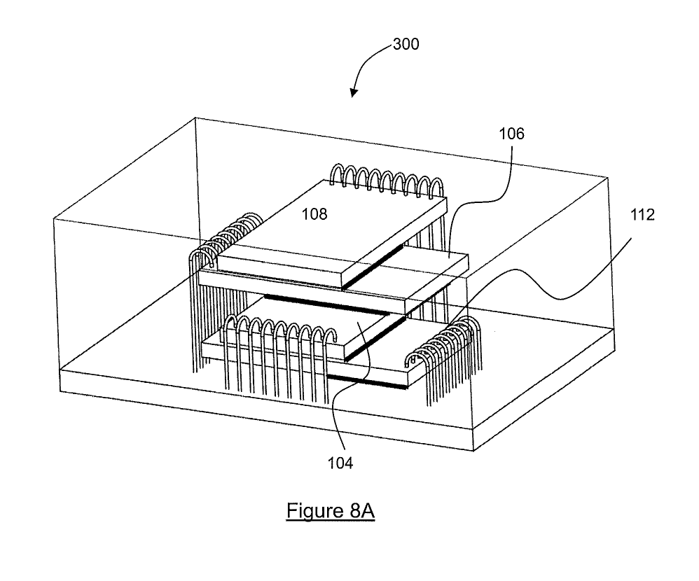

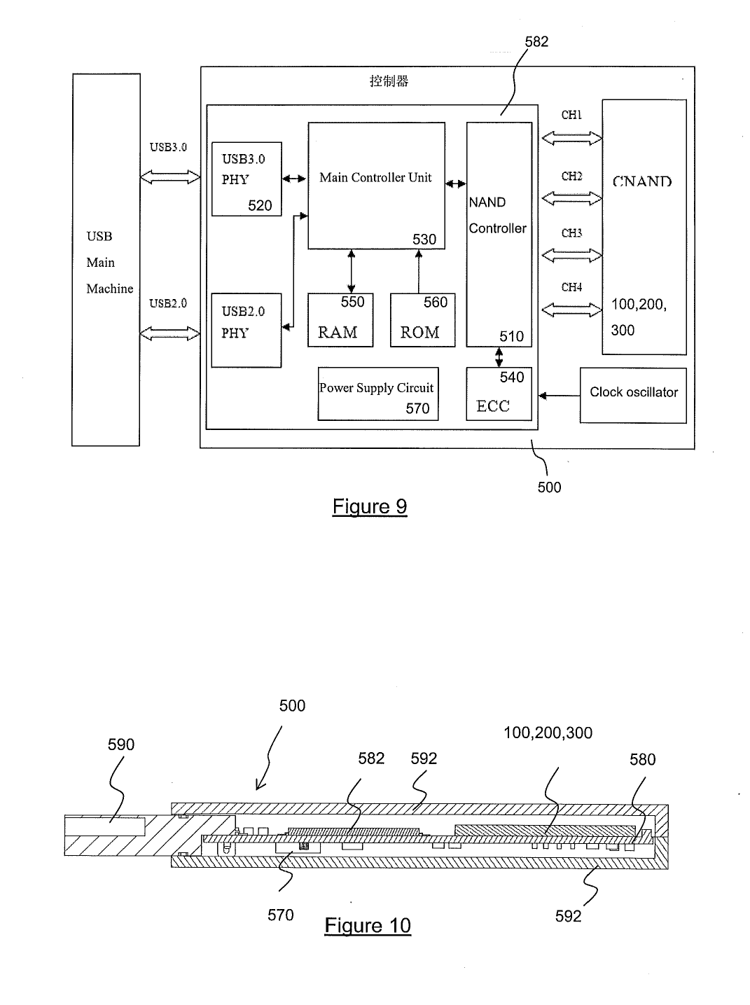

The stack assembly 300 of FIGS. 8 and 8A shows schematically a third embodiment of a flash memory device. The structure and connection of the flash memory dies and PCB are identical to that of FIG. 2, except that the orientation of the contact portion of a die is somewhat different. Likewise, same numerals are used to refer to same, common or equivalent parts. Specifically, the orientation of a die is orthogonal to that of an adjacent die, such that the orientation of the adjacent dies, especially the contact portions of the dies, are at 90 degree separation. In such a disposition, the contact terminals disposed on the PCB are configured to distribute about and surround the stack and more space on the PCB is available for wire bonding.

FIGS. 5 and 5A depicts an exemplary application of the memory device as a USB memory stick which is a convenient application of the present invention.

While the present invention has been explained with reference to the exemplary embodiments above, it should be appreciated by persons skilled in the art the embodiments are only for reference and should not be regarded as restrictive on the scope of the invention. For example, while a rectangular die is used as an example, other shapes, such as square, circular or oval shaped could also be used as the shape of the die. Also, while the exemplary stack comprises 4 dies, it should be appreciated that more than 4 dies could be stacked together and a memory device could be assembled from more than one stack. As a further example, a flash memory assembly having more than 4 data communication channels could be formed by stacking more than 4 flash memory dies by arranging the memory dies such that data input/output (I/O) ports of a die is distributed on the side of a virtual polygon, especially a regular polygon, with the I/O of all the dies distributed on the sides of the polygon.

For example, a 5-channel, 6-channel, 7-channel, 8-channel etc flash memory stack could be formed by arranging the memory dies such that the I/O leads of the dies are distributed on the sides of a pentagon, hexagon, heptagon, octagon, etc. In such an arrangement, the flash memory stack would have an overall polygonal shape when viewed from above.

The block diagram of FIG. 9 illustrates the circuit arrangement of a USB flash drive 500 as an example of a data storage device incorporating a 4 channel flash memory assembly 100, 200, 300 of the present invention. The flash drive is adapted for USB 3.0 compatible and includes a multi-channel flash memory assembly of the NAND type, a NAND controller 510 arranged to cooperate with the flash memory assembly to effect high speed multi-channel data transfer in parallel to and from the flash memory assembly, a USB 3.0 PHY 520 interface for interfacing with a main USB device, and a main controller unit 530 connected between the NAND controller and the USB 3.0 physical layer interface (“PHY”) for control data transfer there-between. In addition, an error checking and correction (“ECC”) arrangement 540 is included and in connection with the NAND controller to facilitate data integrity checking and correction, and the ECC arrangement is connected to an oscillator for clocking signals. Furthermore, RAM 550 and ROM 560 are also connected to the main controller to provide internal memory storage to facilitate internal data management and processing of the flash drive. In order to make the flash drive also compatible with USB 2.0 devices, a USB 2.0 PHY interface is also connected to the main controller as an accessory. In addition, a power supply management arrangement 570 for providing operation power to the flash drive is also provided.

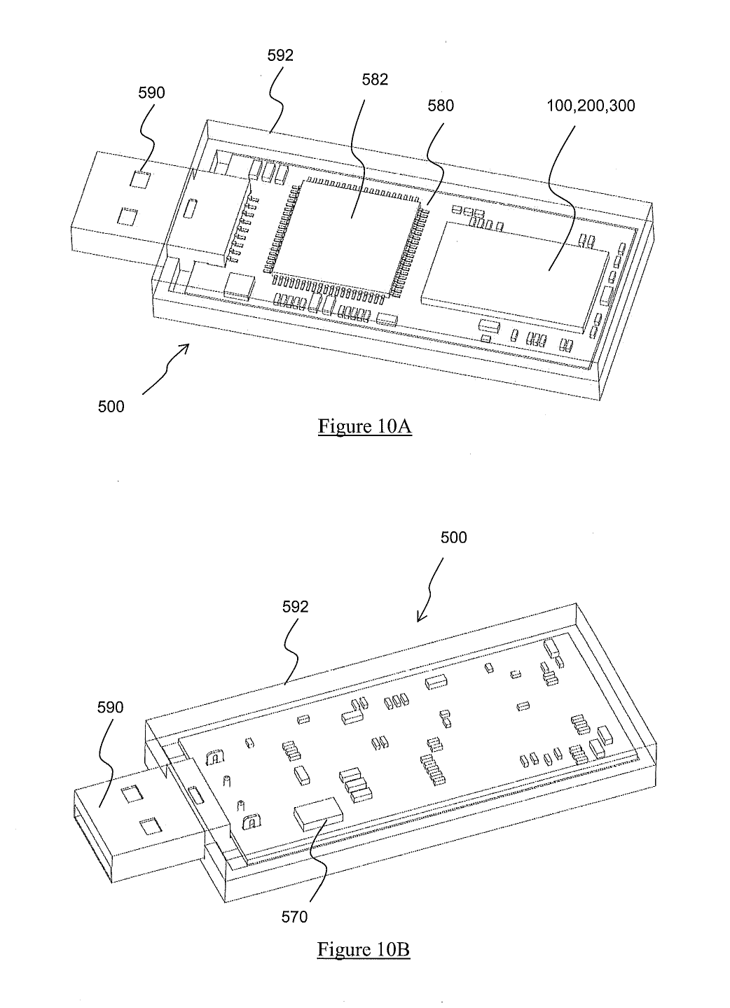

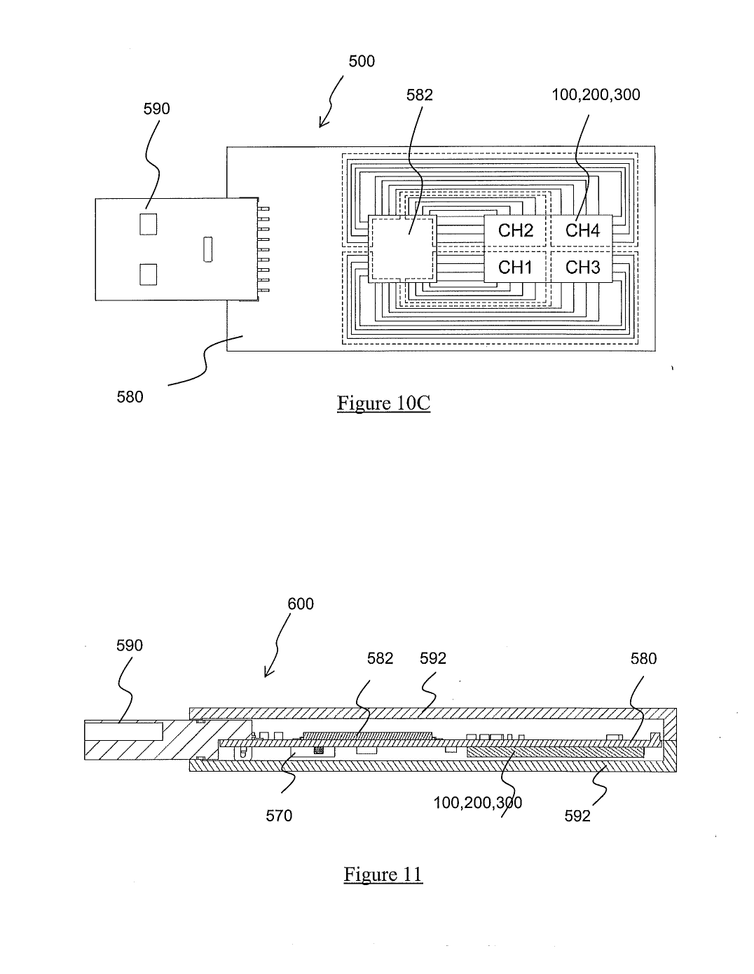

As shown in FIGS. 10, 10A & 10B, the circuit components of the flash drive of FIG. 9 are mounted on a printed circuit board (PCB) 580. Specifically, the data communication control parts such as the NAND controller 510, the USB 3.0 and 2.0 PHYs, main controller 530, ECC 540, RAM 550, ROM 560 and power supply management 570 are formed on a substrate and mounted on an IC package 582 before being mounted on the PCB. The IC package 582 is generally referred to as a USB 3.0 controller. A USB connector 590 is also mounted on the PCB and in electrical communication with the USB 3.0 and USB 2.0 PHY interfaces. This USB connector provides a robust connector for detachable connection between the flash drive and an external data processing apparatus. The assembly comprising the USB connector and the PCB are mounted on a plastic housing 592 to shield the components from the environment. The exemplary component layouts of FIGS. 10, 10A&B illustrates a versatile aspect of this invention in that a high speed USB 3.0 flash drive with a very large storage capacity could be constructed by incorporating the multi-channel stacked flash memory assembly. The use of a multi-channel flash memory assembly comprising a multi-storey stacked assembly of flash memory dies (102, 104, 106, 108) in the construction of this solid state flash drive facilitates a very compact construction since it is not necessary to spread the various flash memory dies on the PCB 580 in order to build a multi-channel flash memory. The schematic diagram of FIG. 10C illustrates connections between the flash memory assembly and the NAND controller. Specifically, lead wires for connecting the flash memory assembly 100, 200, 300 with the NAND controller 530 are distributed on the PCB around the flash memory assembly 100, 200, 300, and the footprint of the flash memory assembly is about the same as that of a single flash memory die 102, 104, 106, and 108.

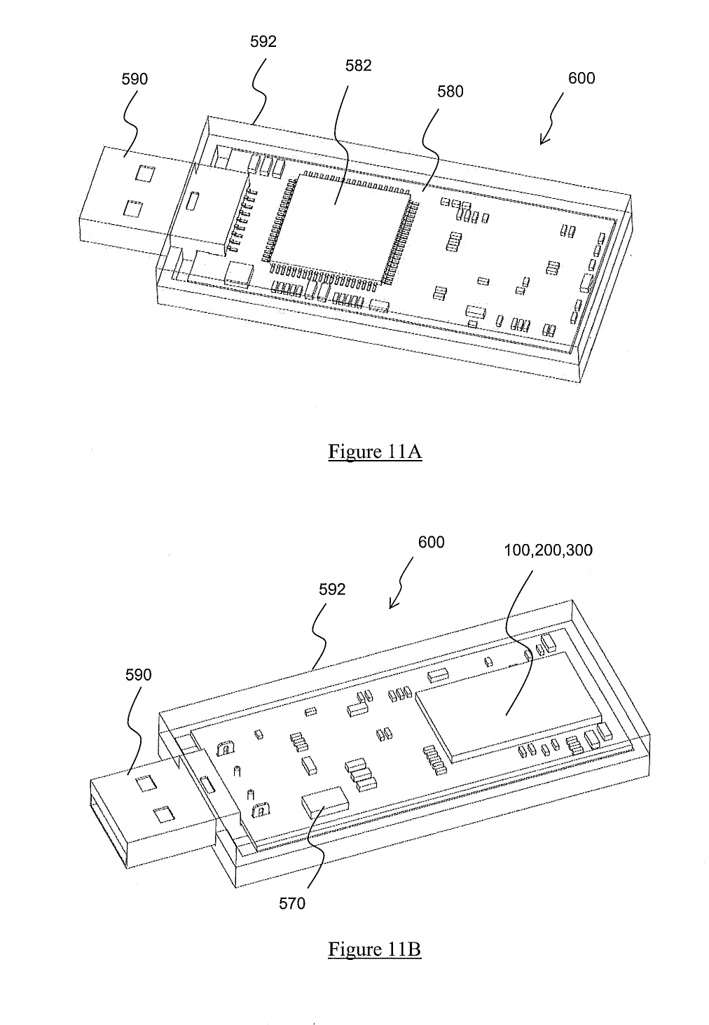

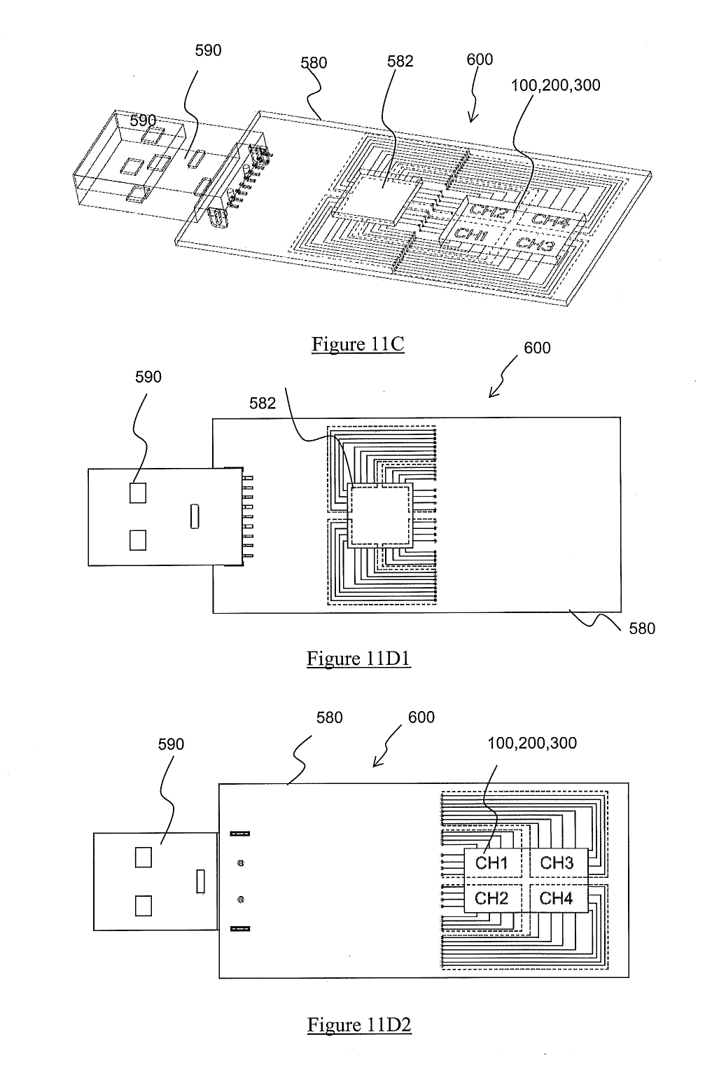

A variation of the flash drive of FIGS. 10 & 10A-C is shown in FIGS. 11 and 11A-C. In this variation, the flash memory assembly of the flash drive 600 is mounted on the side of the PCB 580 opposite to that on which the IC 582 is mounted, and connection between leads on the opposite sides of the PCB is by metal plated through holes.

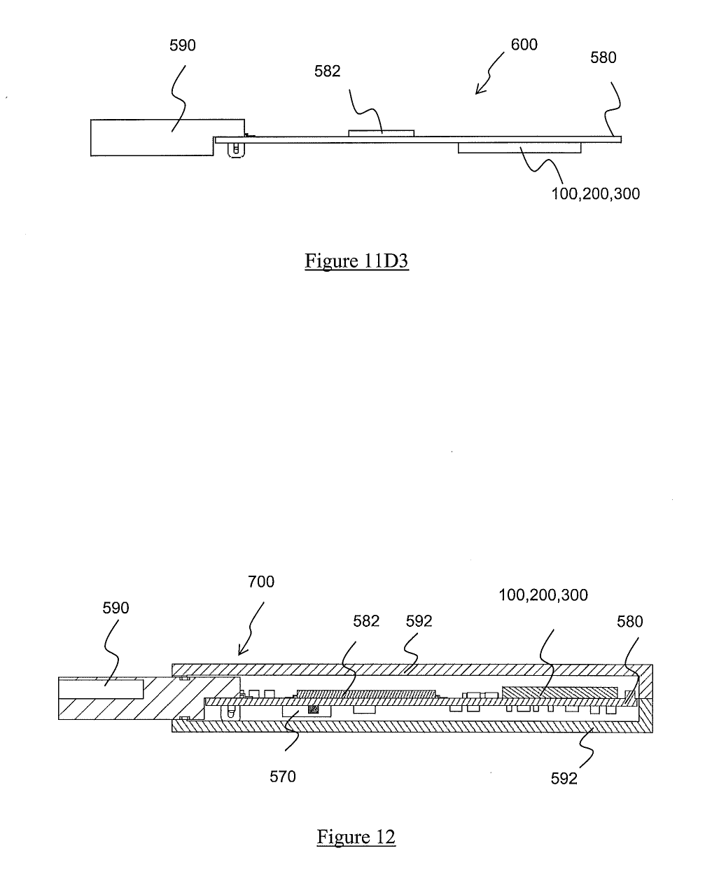

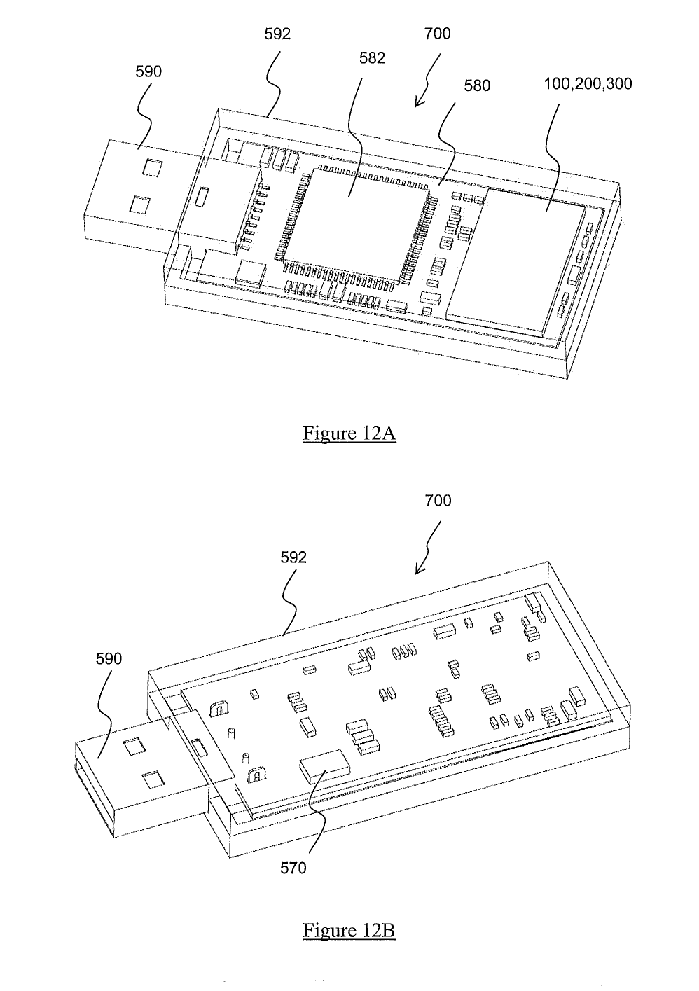

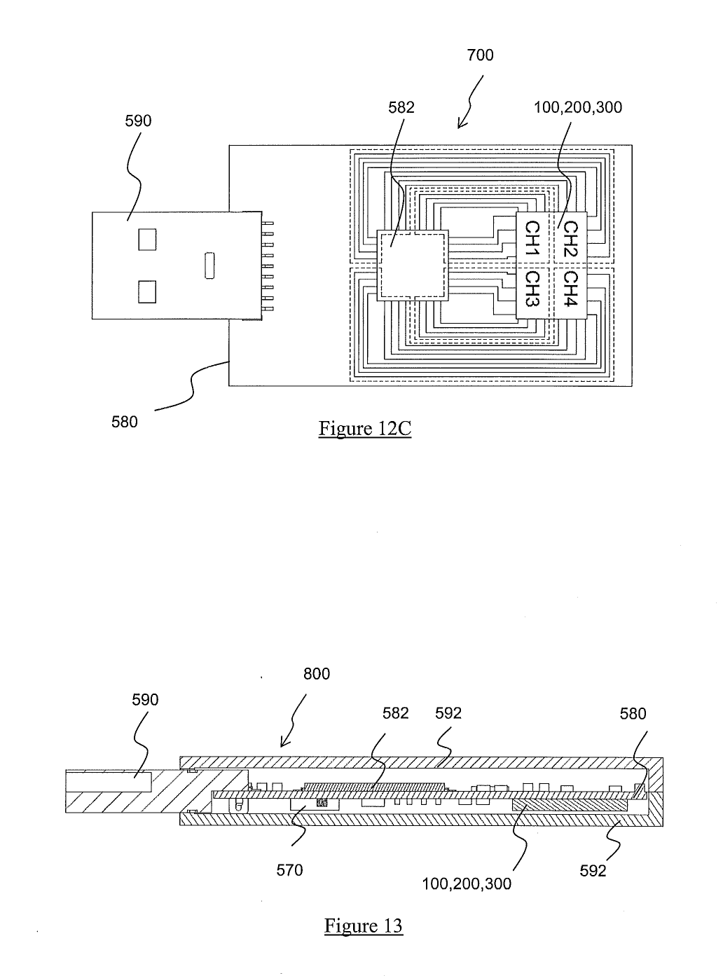

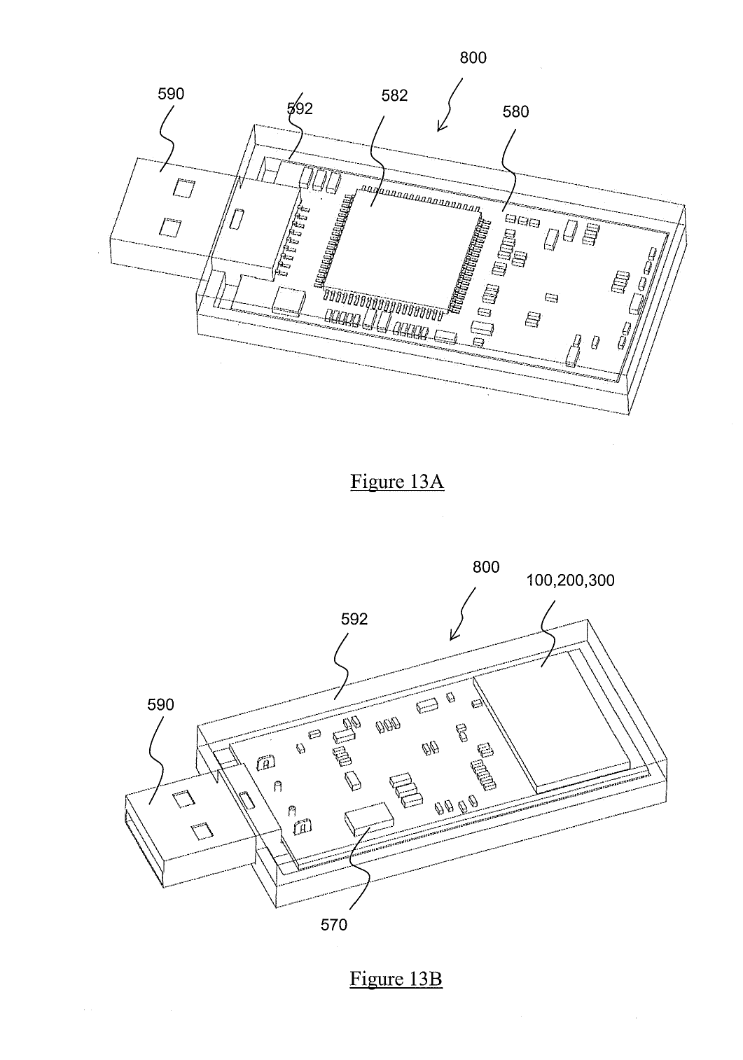

FIGS. 12 and 12A-C depict a third embodiment of a flash drive 700 of FIG. 9 as exemplified by the construction of FIGS. 10 and 10A-C except that the orientation of the rectangular memory stack is tuned by 90 degrees.

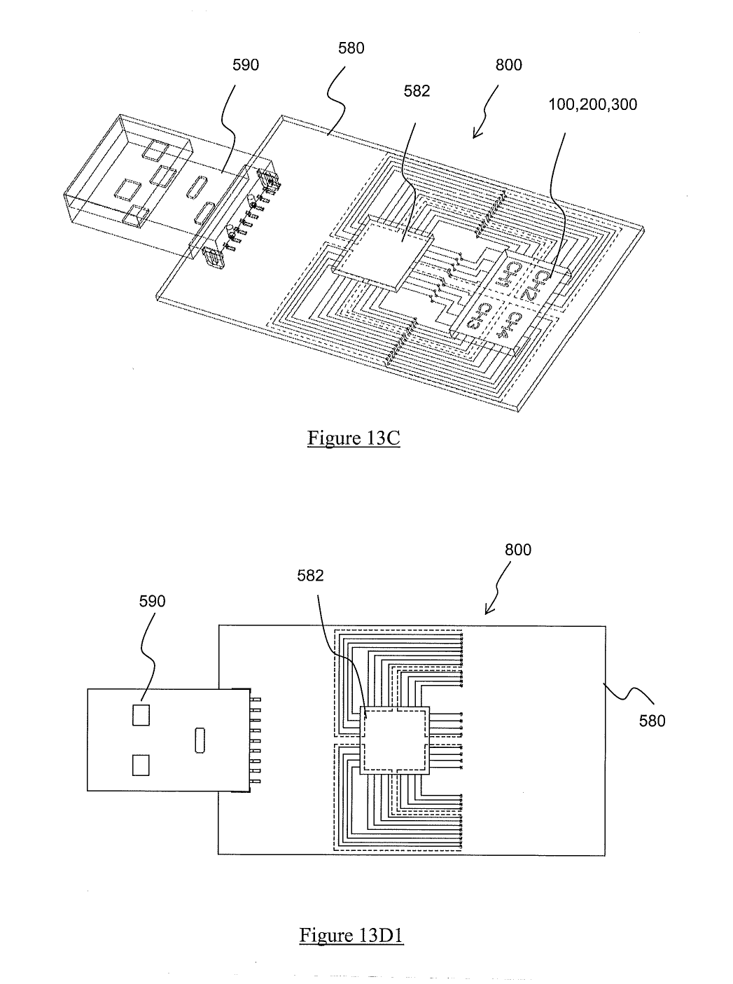

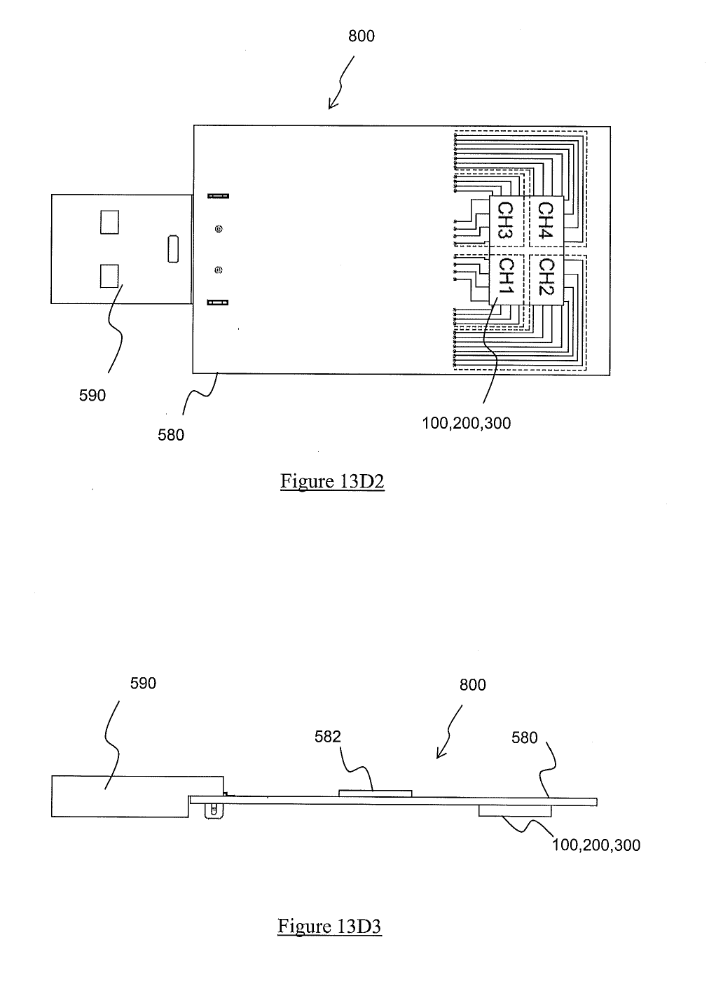

FIGS. 13 and 13A-C depict a third embodiment of a flash drive 800 of FIG. 9 as exemplified by the construction of FIGS. 11 and 11A-C except that the orientation of the rectangular memory stack is tuned by 90 degrees. Similarly, connection between leads on the opposite sides of the PCB is also by metal plated through holes.

In addition to the above embodiments, it will be appreciated that more than one flash memory stack could be included in each flash drive. For example, stacked flash memory assemblies could be mounted on both sides of the PCB, and more than one stacked memory assembly could be mounted on the same side of the PCB, thereby substantially enhancing the storage capacity of the flash drive while maintaining a high speed performance due to the application of this multichannel stacked flash memory arrangement.

While the present invention has been described with reference to the above embodiments, it should be appreciated that the embodiments and construction variations are only for reference only and should not be used to restrict or limit the scope of invention. For example, while the above invention used flash drive as an illustration example, the application methodology of the stacked flash memory assembly could be applied in other data apparatus without loss of generality.

1. A data storage device comprising a multichannel flash memory assembly, the flash memory assembly comprising a plurality of stacked flash memory members.

2. A data storage device according to claim 1, wherein the data storage device is adapted for USB 3.0 or SuperSpeed Universal Serial Bus applications.

3. A data storage device according to claim 1, wherein the flash memory assembly is adapted for multichannel data transfer at a maximum speed of 4.8 gigabit-per-second (Gbps).

4. A data storage device according to claim 1, wherein the flash memory is NAND type, and the device comprises a NAND controller which is arranged to cooperate with the flash memory assembly to effect date transfer between the controller and the flash memory assembly in a plurality of channels in parallel.

5. A data storage device according to claim 4, wherein the device comprises a main controller and a USB 3.0 PHY interface, the main controller being arranged to negotiate data transfer between the NAND controller and the USB 3.0 PHY interface.

6. A data storage device according to claim 4, further including a USB 2.0 PHY interface, and the main controller being also arranged to negotiate data transfer between the NAND controller and the USB 2.0 PHY interface.

7. A data storage device according to claim 1, wherein the flash memory assembly comprising a stack of a plurality of flash memory members mounted on a substrate, wherein each flash memory member comprises a collection of data access terminals such as data input and output terminals, and each data access terminal of each of the plurality of flash memory member is individually bonded on the substrate and is individually accessible through contact terminals on the substrate.

8. A data storage device according to claim 7, wherein at least the data input and output terminals of a flash memory member in the stack are bonded to the substrate by bonding wires, and all the bonding wires of the flash memory member is on one lateral end or side of the flash memory member.

9. A data storage device according to claim 8, wherein the bonding wires on an adjacent flash memory member in the stack is bonded on a lateral side which is opposite the one lateral end or side.

10. A data storage device according to claim 8, wherein the orientation of a flash memory member in the stack is shifted by about 90 degrees with respect to an immediately adjacent flash memory member in the stack.

11. A data storage device according to claim 10, wherein the stacking of the flash memory members is arranged such that the bonding wires of a flash memory member which is sandwiched between two immediately adjacent flash memory members are intermediate the bonded lateral sides of the adjacent flash memory members.

12. A data storage device according to claim 1, wherein the bonding wires of a flash memory member in the stack are bonded at one lateral end of the flash memory member, and the bonded lateral ends of the flash memory members in the stack are on a substantially or generally helical path.

13. A data storage device according to claim 1, wherein the stack is surrounded by bonding wires of the flash memory members, or surrounded by the bonding wires on at least on 4 lateral sides of the stack

14. A data storage device according to claim 1, wherein the stack is arranged such that the bonding wires on opposite lateral ends of the stack are symmetrically distributed about a centre plane of the stack.

15. A data storage device according to claim 1, wherein the data access terminals are bonded to the substrate by bonding wires, and the bonding wires are arranged such that bonding wires on a lower flash memory member on the stack are nested by bonding wires higher up in the stack.

16. A data storage device according to claim 15, wherein the bonding wires are arranged such that the flash memory member at the bottom of the stack is surrounded by an aggregate of bonding wires bonded to the stack.

17. A data storage device according to claim 1, wherein the bonding wires are distributed around the entire periphery of the stack.

18. A data storage device according to claim 1, wherein the bonded portion of a flash memory member of the stack overhangs a flash memory immediately underneath.

19. A data storage device according to claim 1, wherein a flash memory member in the stack is oriented substantially orthogonal to an immediately adjacent flash memory member in the stack.

20. A data storage device according to claim 1, wherein each flash memory member comprises a die of flash memory.

21. A data storage device according to claim 1, wherein the substrate comprises a printed circuit board, including a multi-layered printed circuit board.

22. A data storage device according to claim 1, wherein the stack comprises at least 4 flash memory members, each flash memory members comprising a channel of data input and output terminals; and the 4 channels of the 4 flash memory members are individually accessible on the substrate.

23. A data storage device according to claim 1, wherein the stack comprise a number N of flash memory members, where N=2ⁿ, n being an integer.

24. A data storage device according to claim 1, wherein the collection of data input and output terminals collectively form a communication channel, and the contact terminals further comprises voltage and other non-data terminals.

25. A memory device according to claim 1, wherein the contact terminals of a flash memory member are arranged such that the contact terminals of the flash memory assembly are distributed on the sides of a polygon, such as a regular polygon.

26. A data storage device according to claim 1, wherein the data storage apparatus includes a USB flash drive, a USB memory stick, a solid state hard disc, or the like.
